(19) United States
(12) Patent Application Publication
(10) Pub. No.: US 2004/0162992 A1
(43) Pub. Date: Aug. 19, 2004

(54) Internet privacy protection device

(76) Inventors: Vikash Krishna Sami, Burnaby (CA); Michael Paraskake, Vancouver (CA)

Correspondence Address: Mr. Paul Prade, SAAFNET INTERNATIONAL INC., 5945 Kathleen Avenue, 6th Floor, Burnaby, British Columbia, V5H 4 J7, CA

(21) Appl. No.: 10/364,322

(22) Filed: Feb. 19, 2003

(51) Int. Cl. H04L 9/00

(52) U.S. Cl. 713/200

(57) ABSTRACT

The invention consists of a standalone broadband plug and play Internet privacy protection device that provides complete computer or network security for always-on high speed connections by means of combining a real-time packet inspection process in conjunction with computer or network IP address concealment and implementing a seamless network disconnection upon detection of Internet inactivity by the client.

### FIELD OF THE INVENTION

The present invention relates to security for personal and network computer systems and the prevention of unauthorized access and attacks to such computer systems. In particular, this invention relates to computer security being provided to individual computers or networks utilizing full time broadband network connections to the Internet.

### BACKGROUND OF THE INVENTION

Computer and network security, particularly in relation to the Internet, is an issue of growing concern. Both corporate and personal users face the risk of unwanted theft and/or destruction of applications and/or data from unauthorized outside sources. In the past, Internet communication has been predominately facilitated via dial-up telephone lines whereby the client or network is susceptible to intrusion only for the time they are dialed up and connected to the Internet. When the client's Internet session was completed the user disconnected from the dial-up line or the Internet Service Provider (ISP) initiated a timeout of out the connection by issuing a modem disconnect, thereby dropping the phone line connection and rendering the clients system impossible to be accessed by outside intruders.

The arrival of new high-speed, fulltime Internet connections has lead to an unwanted problem of the user or users being continually susceptible to intrusion and or attacks through the Internet. This security problem is far more prevalent now with the increased number of users utilizing high-speed, fulltime broadband connections to the Internet. In addition, inherent weaknesses in network protocols have made widespread denial-of-service attacks against the availability of network services extremely tempting for many would-be attackers. Therefore, broadband Internet users are much more vulnerable to intrusion and/or attacks and are at a much greater security risk from unauthorized perpetrators.

Currently, the majority of computer network security schemes are provided by additional security application software. The most common types of security software available are firewall and anti-virus packages. Anti-virus software is designed to prevent and remove “virus” programs that can be transmitted via the Internet or loaded from any of the local peripheral devices. Most Internet viruses can be contracted by connections conducting email and FTP sessions to a client's computer. Even if a user avoids using email and FTP sessions the client can also acquire viruses from hackers intentionally sending information specifically to that user or host computer.

The reason that security is an issue on the Internet is that any fulltime broadband TCP/IP connection to the Internet is equivalent to connecting to an extremely large LAN. When a host or network is connected to the Internet, they have also connected to every other computer within that network. This means that anyone on the network potentially has the type of access to gain entry to the interconnected host or attached network. In fact, having the operating system of a computer just connected to the Internet breached by someone who can now connect to it via the Internet is the most probable source of any security problems a full time broadband user will face. It is generally true that the longer an operating system has had TCP/IP built in, the more “back doors” it has for you to assure you have closed. Many corporations and small businesses have backed off from connecting to the Internet because the security threat seems overwhelming and beyond their control. It seems to them that no amount of business advantage is worth the risk involved. If a business has deep security needs, and intends to create a fully secured network they are advised to consult a security expert with the right combination of technical expertise and qualifications.

As more and more of the world's commerce converges onto the Internet, and more and more users have their personal information and identity become resident in cyber-space, the security of the network and connected hosts becomes an issue of major concern. Modest protection such as security application software and firewalls that should provide secure connections are found to be vulnerable to attack and penetration. Users find attacks on their computers that render them useless or cause information from their private files to be sent out to others on the network.

The networking methodology currently utilized by the Internet was originally conceived to enable the establishment of an extremely robust network to be used for critical government communication in the event of a war. The Internet has proven itself as a very robust network against losses of links or routers. It will reconfigure itself to find routes through whatever paths are available. The downfall however, as the current public Internet evolved, the focus on robustness was not extended to take into account such things as security, Distributed Denial of Service (DDOS) attacks, intrusions into routers and network management systems, Local Area Networks, and connected hosts. Assaults such as DDOS attacks that focus large quantities of traffic (packets) on targeted victims like network servers or hosts, will render them and their services unavailable. DDOS and insider attacks on a network are only a couple examples of the security challenges the Internet community is facing.

Attackers have the initial advantage, because they can take time to search for network vulnerabilities of those hosts with full time broadband connections and exercise precise planning in laying the groundwork for an attack. The currently accepted defense stratagem is to put enough layers of network defenses to slow down the attacker, and to increase the probability that the attacker will be detected. If the disposition of an attack can be determined quickly, and if the proper control infrastructure is in place, one can respond immediately as to hopefully counteract the attack, and recover from its effects. This strategy is known as “protect, detect, and respond”, where responding refers primarily to the restoration of service. This methodology is characteristic of solutions typically offered by security software and firewalls and is not considered a proactive approach that provides robustness to the network because of the vulnerabilities in the software that can be discovered and exploited by hackers, criminals, and terrorists.

Firewalls of both the hardware and software types are designed to act as a barrier between a computer or computer network and a connection to an alternate network, i.e. the Internet. Firewalls work by allowing selective access to the computer or computer network from the Internet by meeting certain identification criteria. Firewall security systems can be quite complex and can even have their own hardware and operating systems dedicated to them to ensure a high level of security. However, dedicated operating systems and hardware make firewalls very expensive and complex in their setup, configuration and operation. Complexity can lead to improper or mistaken parameter settings even by fully qualified personnel that can leave the network or client exposed, and risk a security breach. Often the act of applying a new security application, either hardware or software, can result in a loss of the intended security when configuration and settings conflict with other applications, opening up a new security flaw. Firewalls have typically relied on a combination of two techniques, packet filtering and proxy services, in order to provide computer or network security. Firewall technology provides an effective starting point for access control in any distributed network, however, it is not considered a total solution an attempt to use it as such should be treated as a serious security threat.

Packet filtering is the process a firewall uses to selectively control the flow of data to and from a network. A network administrator must establish the rules that specify what type of packets are to be allowed to pass and what types are to be blocked. Packet filtering may occur in a multiplicity of devices such as a router, bridge, access gateway or individual host computer system. Packet filter rules are built for each interface available on a firewall, and they control what data is allowed to flow there. Packet filters can examine and make rules based on any or all of the following: the IP protocol type such as TCP, UDP, ICMP, the source IP address for any type of packet, optionally including the port number, and the destination IP address for any type of IP packet, optionally including the port number. Packet filtering can also control the direction of packets going to a specific interface and thus make different rules for packets that are coming into an interface an those which are being sent out of an interface. The biggest advantage of packet filtering firewalls is speed. Unfortunately, there are many known problems with packet filtering firewalls that hackers can use or exploit. Examples of packet filtering technology can be found in many of inexpensive low-end firewall products.

Proxy firewall services use software to share a fixed known public IP address to the Internet from a network with multiple computer clients using a multiplicity of private internal addresses. When a client program establishes a connection through a proxy to a destination service, it first establishes a connection directly to the proxy server program. The client then negotiates with the proxy server to have the proxy establish a connection on behalf of the client between the proxy and the destination service. Once established, the connection state information is maintained and the content can be filtered if the proxy is configured to expect only certain traffic. As a process is run for each expected service, this type of firewall requires hardware with far greater resources because of loading issues. Another drawback of the methodology is that it is not seamless to the user. All application routing, browsing, and mail needs to point at the firewall or an aliased IP address on the firewall for connections. UDP connections are not processed or handled with any ease as well. Generally speaking, application proxies are slower than packet filtering devices but are in some ways inherently more secure.

In addition, most security devices such as routers, gateways and access servers that provide firewall functionality have an IP address assignment of their own which is visible to the public Internet, Intranet or network they are connected to. The availability of the firewall's IP address is made permanent and fully accessible when the connected network is utilizing an always-on high-speed connection. Having the IP address of a firewall readily available on a persistent basis allows unnecessary exposure and a far greater possibility of an intruder in identifying and attacking it. By discovering the firewall's IP address and allowing this unrestricted amount of connection time, allows every possible intruder with an unlimited number of attempts to uncover and exploit any possible loophole through the firewall and gain entry into the host computer or connected network. Typically an intruder will find and utilize an open port assigned to an application and use this port to infiltrate the host's operating system.

Existing security devices suffer from a common problem that they are implemented in software. This configuration, while considered somewhat effective, is a major problem for administrators who are responsible for ferreting out and tackling security flaws in the base operating system. Many software-based solutions are only as secure as the underlying operating system they are running on and are subjected to many known OS loopholes and faults. As a result, the software itself is susceptible to hacking and may be rendered ineffective. In some cases, the intruder or hacking may remain unnoticed, and become a long-term problem for the victim. Each security breach can result in large losses for the victim whether they be monetary, goodwill, public relations, or otherwise from the theft or destruction of private information. In order to eliminate the risks inherent in software security, a hardware security device is required.

It is the object of this invention to create a standalone hardware security and privacy protection device that does not rely on software of any type and to provide the client with a high level of network security that is essentially impenetrable. It is also the object of this invention to provide this high level of security with the lowest possible cost and the least complexity.

It is a further object of this invention to provide a hardware security device, which is suitable for either a single computer or a multiplicity of connected computer systems. A further object to this invention is to provide a hardware security device that is easily integrated into an existing client or network installation without any software, firmware, configuration or maintenance.

It is also the object of this invention not to trade off the level of security for both the ease of use and installation of the device. Another object of the invention is to provide network or host disconnection when the computer user is not actively surfing the Internet. Yet another object of the invention is to have human intervention required to reestablish an Internet session after disconnection.

Another object of the hardware device is that it is a plug and play zero administration device, requiring no technical or internetworking knowledge in order to be connected to the computer or network. Another object of the invention is to create a security system that is host operating system agnostic and will have full interoperability and work on any platform running the TCP/IP protocol.

Yet another object of the invention is to conceal the IP address or address' s of the computer or computers connected to the device by making them unreachable and undetectable while being connected to the Internet or network. Another object of the invention is that the security device itself has no logical IP or physical MAC address of any type associated with it, as it too remains undetectable, unreachable and transparent to the network it is connected to. A further object of the invention is to make all application ports blocked and hidden at the application layer from the outside world.

Furthermore, another object of the invention is that a user can easily invoke a seamless network disconnect or reconnect at any time during an Internet session. Another object of the invention is that when either a logical or physical disconnection takes place there are no physical layer media alarms or warning signals generated towards the host computer or Internet Service provider indicating any abnormal or interrupted conditions. Yet another object of the invention is to allow the user to maintain or release their computers assigned IP address after disconnection from the Internet Service Provider.

It is another object of the device to have its operational code stored as firmware that is nonvolatile, inaccessible and unalterable from any of the invention's Ethernet communication ports. Another advent of the device is that it has no console or access ports and cannot be accessed via telnet or HTTP browser because there is no IP address associated with the device. It is a further object of the invention to have it's proprietary purpose built operating system reside in a protected part of flash memory which is inaccessible and unalterable from the devices Ethernet ports.

It is another object of the device that to disallow communication or access back to the Internet while the host computer is left unattended, and thus reduces the possibility of Trojans escaping the host computer system.

It is still another object of the invention to use a real time packet authorization process that will ensure online security by continuously tracking host originated connection sessions and employ a stateful packet inspection procedure. An additional object of the invention is that the packet filtering process will require no manual configuration of the filtering rules and will have the intelligence to dynamically select the permissions of ports back to the connected host. The device's embedded functionality will reply with a blocked status from any outside scanning of both TCP and UDP ports and deny access to any of the application layer ports residing on the host.

Another object of the invention is that it will only authenticate and permit host related information to return through the device that the user has specifically requested and will dynamically enforce access control policies verifying the returned network responses are exclusively associated with those host initiated requests. Another object of the invention is to have access control policies pre-defined within the device to eliminate any type of decision making or other presumptions by the user. It is also an object of this invention that the access control policies within the proprietary operating system contain the intelligence to disallow all TCP/IP connection sessions that are considered as vulnerable or distrustful to the security of the computer. It is also an object of this invention to protect against attacks such as flood-based distributed denial of service (DDOS), SYN flooding, ICMP flooding and other attacks designed to exhaust both connectivity bandwidth and system resources. Finally, it is another object of this invention to make the device small and portable to be utilized by telecommuters with notebook computers.

### SUMMARY OF THE INVENTION

The invention consists of a privacy protection device to provide secure access to a computer network, comprising: a host port connected to either a computer or a network of computers and a network port connected to the computer network. The device further includes a communications controller connecting the host port to the network port, with the communications controller generating a single IP access list for monitoring and controlling communication between the host port and the network port. Coupled to the communications controller are an active memory coupled for storing the IP access list and a program memory for storing an operating system (OS) and a TCP/IP stack with a rules set for the communications controller to use in monitoring and controlling communications. The device has a logical disconnection mode which allows the computer to maintain its IP address while being otherwise disconnected from the computer network.

The privacy protection device may also include a physical disconnection mode, which provides for a complete disconnection from the computer network and does not preserve the IP address of the computer by prohibiting all communication between the host port and the network port.

Advantageously, the privacy protection device and the computer or computers connected to the host port of the device are concealed from the computer network, as the privacy protection device does not have an IP address and the communications controller rejects ICMP packets or requests from the computer network.

The invention further includes a method of controlling communications between a computer and a computer network via a privacy protection device, comprising the steps of:

a) passing a URL request datagram from the computer to a destination on the computer network through a communications controller within the device;

b) extracting IP header information from the datagram, the IP header information including the computer's IP address, the destination's IP address, associated port addresses, sequence number and protocol type;

c) storing the IP header information on an IP access list;

d) forwarding the datagram to the destination to receive a response;

e) passing the response through the communications controller and extracting IP header information from the response;

f) comparing the IP header information from the response with the IP header information stored on the IP access list; and

g) forwarding the response to the computer if the IP header information from the response matches the IP header information stored on the IP access list or rejecting the response if the IP header information from the response does not match the IP header information stored on the IP access list.

### BRIEF DESCRIPTION OF THE DRAWINGS

The invention itself both as to organization and method of operation, as well as additional objects and advantages thereof, will become readily apparent from the following detailed description when read in connection with the accompanying drawings:

FIG. 1 is a block diagram of the hardware components of an Internet privacy protection device;

FIG. 2a is the first half of a flow chart showing the communications controller logic; and

FIG. 2b is the second half of the flow chart showing the communications controller logic.

### DETAILED DESCRIPTION OF THE PREFERRED EMBODIMENT

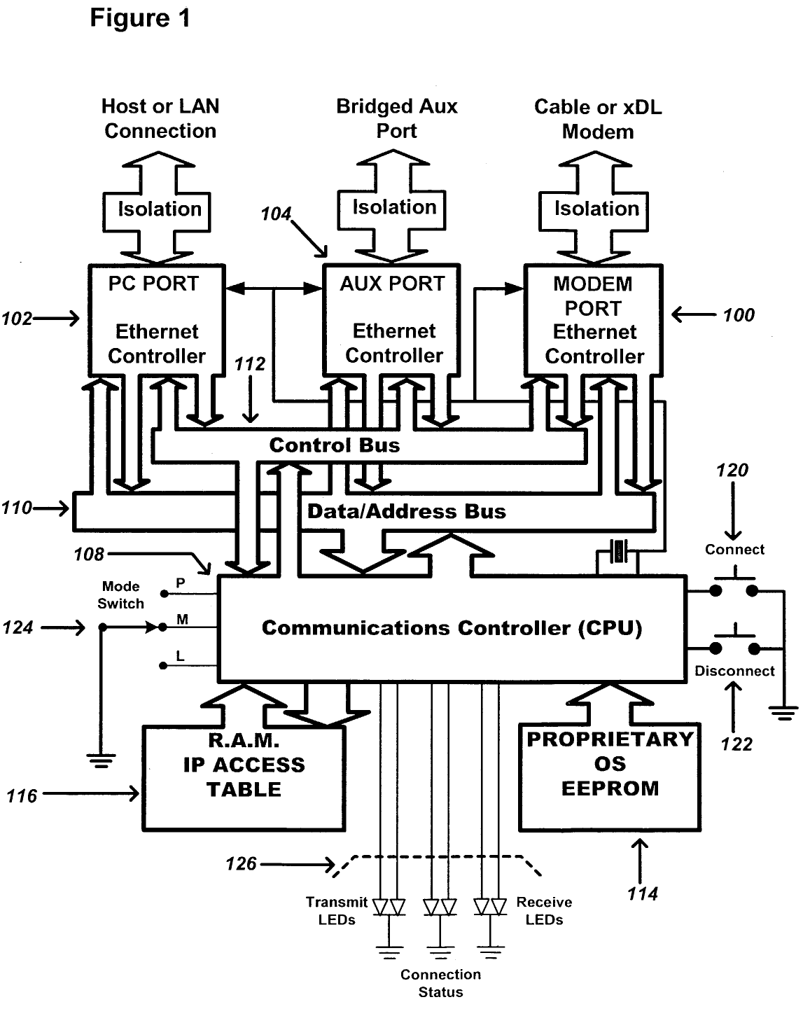

The invention, in its preferred embodiment, is a standalone plug and play Internet privacy protection device that is comprised of, a high-speed Ethernet network port (Internet connection) 100, a fully secured high-speed Ethernet host port (host or LAN connection) 102, and a bridged Ethernet non-secured auxiliary port 104 as shown in FIG. 1. The protection device will operate and be installed between the computer and high-speed cable or DSL modem by interfacing into the baseband signal path utilizing these high-speed Ethernet connections. The bridged auxiliary port 104 is also made available and functions as a non-secured port or DMZ port that can be connected to devices that do not require security or require remote access and administration. The packet forwarding procedures for the DMZ port (bridged port 104) use standard and prior art Ethernet switching techniques that would be understood by those skilled in the art of Ethernet switching. The bridged port 104 uses switching techniques whereby the configurable communications controller 108 will process and forward all packets from either the host PC port 102 or Modem port 100 towards the bridged auxiliary port 104 and from the bridged port 104 only towards the Modem port 100. These Ethernet controller inputs 100, 102, 104 are DC isolated and ESD protected using known components and techniques to anyone skilled in the art of electronic design.

The three high-speed Ethernet controllers 100, 102, 104 are interfaced directly to a configurable communications controller 108 via a multiplexed bi-directional data/address 110 and control bus 112 using standard architecture in micro-controller design known to those who are knowledgeable in the art of microprocessor interfacing. These buses 110 and 112 are the paths by which data is transferred and switched between the Ethernet controllers 100, 102, 104 under control of the proprietary operating system and configurable communications controller 108. The configurable communications controller 108 uses a RISC based architecture that allows high-speed communication combined with flexible I/O control and efficient data manipulation. The architecture is deterministic and totally programmable using single-cycle instructions to implement hard real-time functions as software modules to replace traditional hardware functions. The proprietary device includes two 16 bit timers with 8 bit prescalers supporting different operating system modes, a general purpose 8 bit timer with prescaler and analog comparator, watchdog timer, brown out detector, and high current outputs. The device supports enough SRAM 116 and EE/Flash 114 program memory to store and operate the proprietary purpose built operating system.

The data transmission and packet forwarding processes through which these high-speed Ethernet ports 100, 102, 104 communicate, is electronically controlled by proprietary firmware that resides within a protected area of EPROM 114 contained in the configurable communications controller 108. The real-time OS that is retained in EPROM 114 is implemented in assembler to minimize real-time demands and provide the full bandwidth of the Ethernet Controllers 100, 102, 104. Concurrent control of these high-speed Ethernet ports is also made accessible and is extended via the devices operating firmware to two manual pushbuttons 120 and 122, for connecting and disconnecting as depicted in FIG. 1. The mode and security level is user selectable via a three-position slide switch 124 also shown in FIG. 1. The mode position setting from the mode selection switch setting 124 is read into memory by the operating system and enables one of three types of security levels available on the device. Also included in the device is an intuitive LED status display system 126 that continuously updates indicating the real-time status of the connection and data transmission.

The device establishes Internet security and computer privacy by making the user's computer IP address unreachable and undetectable to unauthorized and unsolicited TCP/IP connection attempts. In addition, during any valid TPC/IP connection session, unauthorized access to all application ports will be disallowed and fully blocked while controlling information in and out of the device. Security is also provided in the time domain of the connection as the device automatically provides computer disconnection (logical or physical) from the Internet or connected network when user Internet inactivity is detected. Additionally, TCP/IP connections that are established and written into the active IP access list from the host are also timed out to deny any previous session requests from re-establishing a connection back to the originating computer. Prior art security devices such as firewalls do not limit their network connection times during unused traffic periods and therefore are subjected to unnecessary exposure and security risks by their continuous presence on the Internet. The privacy device itself does not have either a physical layer MAC address or a logical network layer IP address assignment associated with it and therefore eliminates any requirement for a local console port or HTTP Web Browser interface for IP address configuration or parameter settings.

In the preferred embodiment of the invention the device will be operated while being connected between a computer or LAN and broadband modem utilizing a full time high speed Internet connection. The privacy protection device contains it's own embedded purpose-built TCP/IP stack and proprietary set of security rules supporting both TCP (RFC 794 and 1323) and UDP (RFC 768) protocols at the transport layer. In addition, by default, the device will suppress and discard all network layer ICMP control messages (RFC 792) that arrive on the network side interface, thus making any connected host or hosts on the protected interface (host port 100) unreachable and undetectable from the Internet or a connected network. The device will permit, via an intelligent permission rules set, a multiplicity of common Internet application protocols such as HTTP (RFC 1945 and 2068), FTP (RFC 959), TFTP (RFC 1350), SMTP (RFC 821), POP3 (RFC 1939), IMAP (RFC 2060), DNS (RFC 1034 and 1035), DHCP (RFC 2131), RTP (RFC 1889) and Ipsec (RFC 3193). The device will deny all insecure connections such as peer-to-peer communication using MSN Messenger or any similar peer-to-peer sessions. The device will also prohibit hazardous protocols such as NetBIOS (RFC 1001 and 1002) operating on ports 137, 138 and 139 as it is an unauthenticated protocol by design and therefore subject to spoofing. Another common denied protocol is Telnet (RFC 854) utilizing port 2 and other private port numbers.

A typical host URL request is described in order to illustrate the intended functionality of the device when connected to a single host. Prearranged on the host workstation will be the preprogrammed networking parameters contained within the host's operating system. These preset parameters will include the host's DHCP or statically assigned computer IP address, the IP addresses of the primary and secondary DNS servers, and the default gateway address. The host computer will firstly be pre-assigned a public IP address by establishing a DHCP communication session through the privacy protection device from the Internet Service provider's DHCP server. The DHCP sever will respond with a DHCP offer containing and IP address used solely during setup whereby the host will respond and be acknowledge by the DCHP of the IP address lease. The host computer will be assigned a static or dynamic IP address from the Internet service provider. The host user will start by making a website request from the host computer using any Internet web browser.

The user will request a website by pointing the host's Web Browser to a URL and the URL request datagram will be passed from the host computer to the host port 102 of the privacy protection device. The URL request will be resolved first by directing the request to a DNS server where the URLs are translated to an IP address complying with RFC 1034 and 1035. The IP header information sent contains both the source address (host's IP address) and destination address (DNS server's IP address), along with the associated UDP source and destination port addresses and other referential fields needed for the session. The URL request passes through the Internet privacy protection device, where a copy of the IP header information within the IP datagram is extracted. IP header information is extracted in order to store the host's source and DNS destination's IP addresses, the associated UDP port addresses, the type of protocol being utilized, the packet sequence number (if TCP is used) and several other selected fields within the TCP/IP header. This IP header examination and data extraction process is accomplished by the use of the two Ethernet controllers 100, 102 and configurable communications controller 108 that internally stores the source and destination referenced IP addresses, UDP or TCP port addresses and other extracted information into an IP access list table within the controller 108.

The configurable communications controller 108 dynamically creates this IP access table by writing and saving all outgoing session requests containing source and destination IP addresses, TCP or UDP port address information (depending on the application), protocol type, sequence number and other fields into an IP access list within a block of active read/write memory 116. The host generated IP header and payload information is then forwarded to the network side Ethernet interface 100 towards the Internet where the datagram is routed via the destination IP address to the destined DNS server. At the destined DNS server, the requested URL is resolved into a public IP address and is transmitted back to the host that initially made the request. The returned IP datagram will contain the source address (being the IP address of DNS server), the destination address (being the IP address of host computer), the associated UDP port information and the encapsulated and resolved IP address of the URL that was initially requested by the host.

The information is routed back over the Internet to the host via the broadband connection through the high-speed modem and enters the network side Ethernet port 100 of the privacy protection device where the IP and UDP header information is extracted and processed for legitimacy by the configurable communications controller 108. The configurable communications controller 108 compares the swapped source IP address (address of the DNS server), the destination address (address of the host), the type of protocol used, the incremented value of the packet sequence number, and other selected fields, to the information contained within the IP access list memory 116 for a direct correlation to the initial URL request. The configurable communications controller 108 will compare these two IP and port addresses along with the protocol type, sequence number increment and other fields, and if an exact match occurs the configurable communications controller 108 will permit the returned information and send it to the host port 102 towards the computer or LAN.

The verification processes will use additional fields within the TCP/IP header to further determine that the returned information is associated with originating requested user session. The host computer's browser application receives from the DNS server the returned encapsulated and requested URL's IP address and now attempts to access this site by using this resolved IP address as the destination address in a subsequent session. The IP datagram is forwarded to the Internet privacy device's host port 102 again containing the host's IP address (source IP address) and the URL's IP address (destination IP address) along with the other information. A copy of the IP header information is again extracted by the configurable communications controller 108, where the host's IP address, URL's IP address, TCP ports and protocol information, sequence number and other fields for the session are also entered into the IP access list. The IP datagram is then forwarded towards to the network through the privacy protection device and is routed over the Internet to the destination URL site.

The URL site responds back to the originating host with the requested information being encapsulated by its IP header containing the source IP address (URL's address), the destination IP address (hosts IP address) and their associated TCP ports that are required to be used by the hosts application. Again, the information packet is returned to the host via the Internet and broadband connection through the high-speed modem and enters the network side port 100 of the privacy protection device where the IP and TCP header information is extracted by the configurable communications controller 108 and searched within the access list for a corresponding session match. The intelligent correlation and verification algorithm allows the configurable communications controller 108 to compare the returned and swapped addresses within the IP header. It compares the for source IP address returned from the URL server to the requested destination IP address that was initially stored by the host request into the IP access list (address of the URL). It also compares the swapped inbound destination IP address from the URL server to the initial requested source IP address that was also initially stored (the address of the host). In addition, the swapped TCP ports, protocol used, packet sequence number and other selected fields within the session connection are also verified for an exact match before allowing the transmission of the IP datagram to pass through the privacy protection device towards the host Ethernet interface 102. This repetitive authentication process through the referencing of returned IP header information to the previously saved IP header information accumulated within the IP access list provides the certainty of unequivocal association of sessions, thus allowing only verified and user requested information to be passed to the onto the host port interface 102.

Subsequent to a predetermined and continuous amount of Internet inactivity time being detected on the host interface port 102 of the protection device, the communications controller 108 will invoke either a logical or physical disconnect between the network 100 and host 102 Ethernet interfaces. The logical disconnection state algorithm permits the communications controller 108 to specifically authorize and forward DHCP UDP type messages bi-directionally to application ports 67 and 68 between the host 102 and network 100 Ethernet interfaces on the privacy protection device. This essentially disconnects the host from the Internet but enables the host to retain its current IP address lease assignment during the disconnection state. No other TCP or UDP communication sessions can be established from either the host or network side of the privacy protection device until a reconnection is established via the manual depression of the connect button 120. Following a physical disconnect, the disconnect algorithm instructs the communications controller 108 not to authorize or forward packets of any type whatsoever between the two interface ports on the privacy protection device, which essentially emulates a physical disconnect by ceasing all packet transmission. If the host IP address was initialized via DHCP communication, the IP address will be released after the lease time expires on the DHCP server. If the IP address was statically assigned, the address will be retained and remain the same after the reconnection process by manually depressing the connect button 120.

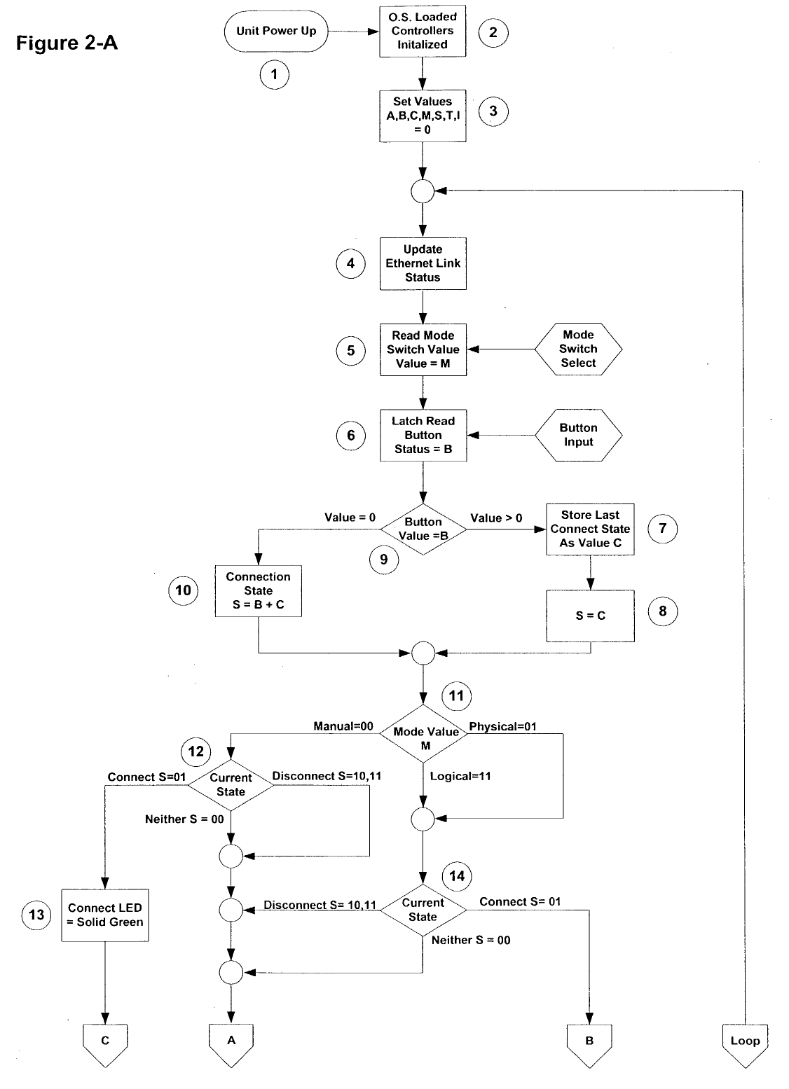

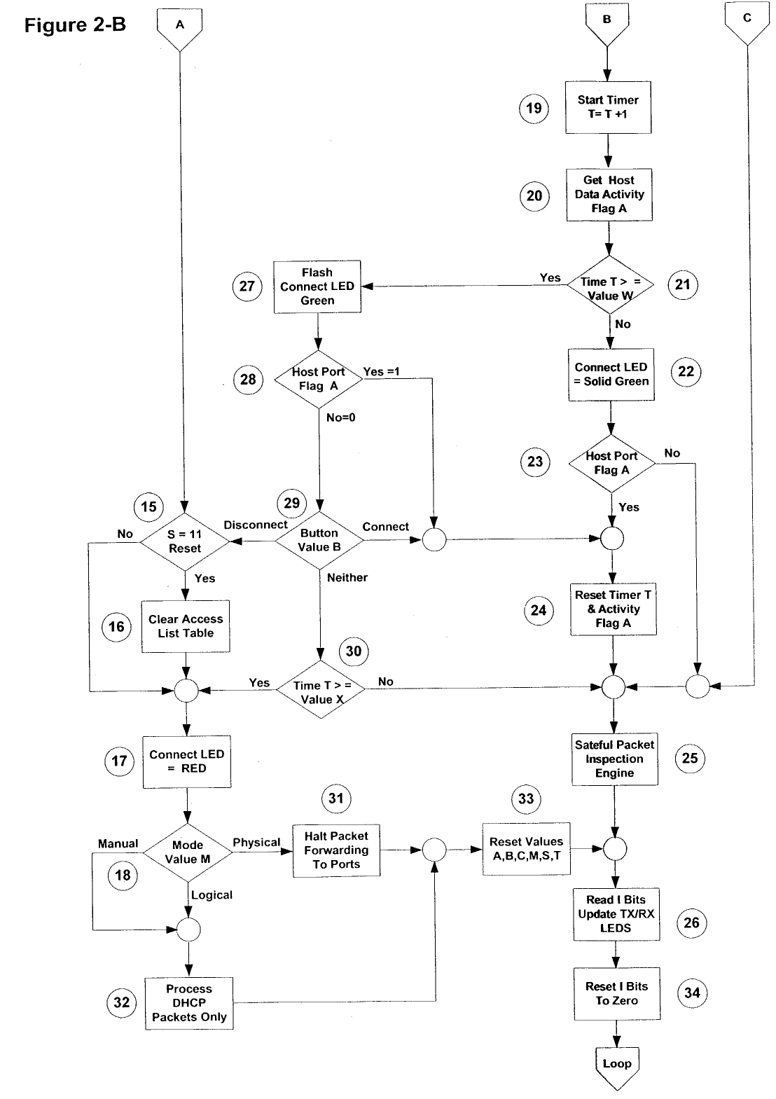

The flowchart in FIGS. 2a and 2b depicts a flow chart to illustrate the combination of sequences and processes that achieves the invention's overall enhanced security. The flowchart diagram represents general program flow and does not represent any actual or hardware specific commands that someone familiar in the art could identify with. The flowchart also does not illustrate or indicate any allotted processing times or priorities to each of the computational modules as these modules could be interrupt driven, depending largely on the hardware implementation. These processes could be flowcharted in a different manner or sequence by those who are familiar in the art that results in the same outcome by combining processes or using alternative hardware.

Step 1—The privacy protection device is powered up and power on is indicated by a red connection LED.

Step 2—Upon the initial powering up of the Internet privacy protection device, the internal configurable communications controller 108 boots up and loads the purpose built operating system from a protected part of EEPROM 114. The configurable communications controller 108 firstly initializes various operational parameters of the Ethernet controllers 100, 102, 104 by forwarding the appropriate mode commands to establish full duplex operation, auto detection of medium interface, interrupt configuration values and other logical device command and control register values settings necessary to establish communications to the connected Ethernet ports 100, 102, 104 and to the configurable communications controller 108. These register parameters are proprietary to the manufacture of the Ethernet controllers utilized but would be understood by those who are familiar in the art of Ethernet communications.

Step 3—The configurable communications controller 108 initially establishes and sets a multiplicity of state variables to a binary value of zero. B (Button Status), C (Last Depressed Button Value), A (Host port Data Activity Flag), M (Mode Switch Value), S (Last Connection State), T (Timer value), and I (Indicator bits) are all initialized to a initial value of zero within the program and I/O memory space allocated and situated in RAM. Fixed and non-volatile values are: W (warning timer value), X (Expired host connection time) and D (Delete expired session map entry).

Button status, variable “B”, is a two bit binary value that is read from an I/O port representing which of the buttons, connect 120, or disconnect 122 or both has been manually depressed. The depression of the connect button 120 will input a binary value of 01, the depression of the disconnect button 122 will input a binary value of 10, the simultaneous depression of both buttons 120 and 122 will input a binary value of 11, and the depression of neither button will input a binary value of 00 across the I/O bus and is subsequently read into memory. Last depressed button variable “C” is a two bit latched binary value stored in memory representing which combination of the two buttons 120 and 122 were manually depressed last. If variable “IC” is a binary value of 01, it indicates the connect button 120 was depressed, if it has a binary value of 10 it indicates the disconnect button 122 was depressed, and if “C” is a binary 11 it indicates that both buttons 120 and 122 were simultaneously depressed last. The Host port data activity flag variable “A”, is a single bit binary value stored in memory representing valid host port originated traffic. A binary value of 1 indicates valid host originated activity while a binary 0 indicates no host originated data activity.

The Mode switch value variable “M”, is a two bit binary value read in from an I/O port indicating one of three possible security modes that has been selected by the user. The selection of the Manual Mode will input a binary value of 00, the selection of the logical mode will input a binary value of 11, and the selection of the physical mode will input a binary value of 01 across the I/O bus and subsequently is read into memory. The Last connection state variable “S”, is a two bit binary value stored in memory and is determined from variables “B”, Button Status and “C”, last depressed button. A last connection state of “S” equaling a binary value of 01 indicates that the user has manually requested the connected and online state for the privacy protection device. A last connection state whereby “S” equals a binary value of 10 indicates that the user has manually requested the disconnected state of the privacy protection device. Where the last Connection State “S” is equal to a binary value of 00, it indicates that no new selection has taken place since the last user selection. A binary value equal to 11 for “S” also indicates that the user has manually requested the disconnect state, but additionally wishes to purge the current and active contents of the privacy devices active IP access list retained in RAM 116.

Timer value variable “T” is a 16 bit binary value representing a timer value of the RTCC, Real Time Clock Counter residing within the communications controller 108. This timer value “T”, is started and incremented whenever a connect state has been requested by the user via the depression of the connection button 120. The timer value “T” is reset back to zero and starts re-timing the connection state if either the connect button 120 has been depressed again or the activity flag “A” was sensed to be active again as a binary value 1. If neither of these two events occur and timer “T” reaches a value that greater than or equal to value “X”, a subsequent disconnection dependant on the Mode value of “M” will take place and timer “T” is reset back to a starting value of zero awaiting a new connection request. The “I” indicator variable is a set of four bits located in memory that is continuously updated and will be used to update the transmit/receive link status LEDs 126 displaying valid or unauthorized packet transmission. Two binary bit locations represent valid or invalid transmit packet transmission and two binary bit locations represent valid or invalid packet reception. The bits will be set to a binary value of 1 or 0 upon determining the validity of the packet being received or transmitted. These indicator bits are then continually read out from active memory and outputted to an I/O port to update the visual link status LED display 126.

Step 4—The host 102 and network 100 Ethernet ports current link status is interrogated and updated in the subsequent process. Commands are issued and addressed from the configurable communications-controller 108 to each of the Ethernet controllers that request and retrieve the current link status state of each Ethernet controller. The Link status state results are returned to the configurable communications controller 108 and used to update via an I/O port the illumination of a green link status LED for each of the ports. The link status is for visual purposes to indicate to the client whether proper continuity and communication exists between the Ethernet controllers and the connected devices such as the host network interface card and high-speed Cable or DSL modem network device.

Step 5—The following process stores the Mode setting by reading in the physical switch position the user has selected. A user selectable three-position slide switch 124 setting is used to choose the mode and level of disconnection required by the host computer or network. Instructions are executed to read a two bit binary value into a memory location via a selected I/O port on the configurable communications controller 108 from the current physical position of Mode selector switch 124. The binary value is saved in a memory location as value “M”. This Mode value “M” will determine what type of network disconnection will be applied to the host port upon Internet inactivity timeout where timer value “X” has been exceeded or via manual intervention by depressing the disconnect button 122. One of three possible binary values are read in from the slide switch I/O port and saved into active memory depending whether a logical, physical or no disconnection is selected by the user.

Step 6—The next value read and saved into memory is a two bit binary value “B” representing the Button Status. The Button Status value determines what button if any has been depressed by manual operation. The buttons 120, 122 are depressed by a user to establish either a connection or disconnection of the host computer to the Internet or coupled network. The two user accessible buttons 120, 122 are functional regardless of what user mode “M” has been selected. Instructions are executed to read the current two bit binary value “B” into a known memory location via a selected I/O port on the configurable communications controller 108. This binary value “B” is scanned and into an active memory location. The depression of neither button is read into memory as a binary value of 00. The depression of the connection button 120 is read into memory as a binary value of 01. The depression of the disconnection button 122 is read in as a binary value of 10, while the simultaneous depression of both buttons 120 and 122, results a binary value of 11 being read into memory requesting a disconnect and resetting the entire IP access list table.

Step 7—The subsequent step now examines the binary value of “B” and decides if a button has been depressed. Instructions are executed to fetch and read the memory location that contains the binary value of “B”. Instructions are executed to determine if the binary value of “B” is greater than zero and if so, a button has been depressed and this value is stored into a memory location as value “C”. Step 7—Value “C” contains the last depressed button's binary value. Step 6—If the binary value of “B” is equal to zero then neither of the buttons has been depressed or no updated button activity has taken place. Step 10—Instructions are executed to add the current binary value of “B” equaling zero, with the previous value of “C” and saving the sum as a binary value in a memory location as value “S”. Step 10—The value of “S” now contains the binary value of the last requested state and can have four different values. A binary value of 01 indicates the connection button has been depressed. A binary value of 10 indicates the disconnection button has been depressed, a binary value of 00 indicates that neither button has been depressed and a binary value of 11 indicates that both buttons were depressed simultaneously. The memory location containing the binary value of “S” holds the latched binary value equal to the last user requested state of the button or buttons that were depressed.

Step 11—The succeeding step will examine the mode value “M” to decide what type of security disconnection timing is required. Instructions are executed to read and examine the contents of the memory location containing the value of “M”. If the Mode value of “M” is equal to a binary value 00, the manual mode of disconnection is required and will proceed to interrogate the memory location containing the current value of “S” in order to determine port connection or disconnection.

Step 12—Instructions are executed to fetch and examine the memory location of “S”. If the value of “S” equals a connect binary value of 01, an output is generated to an I/O port to illuminate the connect status LED to green (Step 13) indicating there is communication enabled between the host Ethernet port 102 and the network Ethernet 100 port on the privacy protection device. The configurable communication controller 108 will now pass TCP/IP Ethernet frames between these two connected ports but the TCP/IP frames are subject to the packet inspection rules module (Step 25) described later in detail. (Step 12) If the interrogated value of “S” does not equal connection state binary of 01, the value of “S” is forwarded to (Step 15) whereby it “S” is examined for a disconnect or disconnect reset function. (Step 15) The value of “S” is interrogated for a binary value that is equal to 11. If the value of “S” is equal to a binary value of 11, a disconnect reset function, subsequent instructions are executed within module (Step 16) to immediately delete the entire IP access table list of all active session entries followed by (Step 17) the sending of an output I/O command illuminating the connection status LED to red indicating that the communications path between the host 102 and network 100 Ethernet controllers have been disabled by the configurable communications controller 108.

(Step 15) If the value of “S” equals a binary value of 00, a timed disconnect, or a binary value of 10, a manual disconnect, the immediate clearing of all active session entries within the IP access list in process (Step 16) is bypassed. This allows the current active session entries within the access table to be individually and dynamically deleted upon subsequently determining that each saved session entry has not been referenced and has remained inactive for a timer period equal to or greater than the value of “D” in module (Step 25). After bypassing process (Step 16) an output command is issued to generate an I/O signal (Step 17) illuminating the connection status LED to red signifying that the communications path between the host 102 and network 100 Ethernet controllers has been disabled by the configurable communications controller 108.

(Step 18) Instructions are executed again to fetch from memory and interrogate the Mode value “M” to determine the type of host port disconnection that is will be activated. If the Mode value “M” is equal to binary values 00 (Manual Mode) or binary 11 (Logical Mode) the subsequent packet filtration process (Step 32) will be enabled that only allows DHCP type packet messages to be processed and passed by the configurable communications controller 108 between the host 102 and network 100 Ethernet ports. The host outbound DCHP messages (RFC 2131) are allowed to pass through the host port to the network side port and visa versa while all other remaining TCP/IP ports are disallowed access and remain blocked. (Step 32) By allowing only DHCP type messages per RFC 2131 to be processed in the TCP/IP stack by the configurable communications controller 108, the host or hosts are logically disconnected from the associated network and no TCP/IP communication can be initiated from either the host or network ports. Only TCP ports 67 and 68 are allowed to communicate between the host and network ports. This will allow the host to retain its IP address that has been assigned from the service providers DCHP server and will be able to hold its assigned lease time via the authorized DHCP communication.

In addition (Step 32) also updates transmit and receive indicator bits “I” stored in four single bit memory locations. Two single bits are used to indicate valid and discarded transmit packets originating from the host, and two bits are used to indicate valid and discarded receive packets originating from the network port. Only one of the bits will be set to a binary value of 1 in either direction at any time, and is read in from active memory in module (Step 26) to update the intuitive LED display 126. Valid packets will be displayed by the transmit and receive link LEDS switching from green to off to green, and invalid packets will be displayed by the transmit and receive LEDs switching from green to red to green. With a logical disconnect state active only DHCP messages will flash the transmit and receive link LED's green. (Step 18) If the examined Mode value “M” is equal to binary value of 01 (Physical Mode) the subsequent type of port disconnection takes place. (Step 31) Instructions are executed so all TCP/IP packet transmission between the privacy devices host's 102 and network's 100 Ethernet controllers is ceased by the configurable communications controller 108. With no packet transmission allowed whatsoever between the two Ethernet ports, it effectively establishes the same effect of a physical disconnection of the devices that are connected to the associated Ethernet ports. No TCP/IP traffic can pass at any of the four Internet layers and therefore no communication whatsoever can be established in either direction through the privacy devices ports. The host computer or computers will now relinquish the hold on their assigned IP addresses after their lease time expires on the service providers DHCP server. If the IP address was initially statically assigned, it will be retained after a reconnection is established by manual intervention through the depression of the connect button 120. In addition, (Step 31) also updates transmit and receive indicator bits “I” stored in four single bit memory locations. Two single bits are used to indicate valid and discarded transmit packets originating from the host, and two bits are used to indicate valid and discarded receive packets originating from the network port. Only one of the bits will be set to a binary value of 1 in either direction at any time, and is read in from memory in module (Step 26) to update the intuitive LED display 126. Valid packets will be displayed by the transmit and receive link LEDs switching from green to off to green, and invalid packets will be displayed by the transmit and receive link LEDs switching from green to red to green. In the physical disconnect mode all packet transmission is considered invalid and the “I” bits are set accordingly in memory.

Returning to Step 11, if the examined Mode value “M” is equal to binary value 11 or 01 the Logical or Physical mode, a timed disconnection is enabled and will proceed to Step 14 to interrogate and examine the memory location containing the current value of connection status “S” to determine port connection or disconnection. If the interrogated value of “S” (Step 14) equals a disconnection, binary values of 10, 11 or 00, Step 15 will examine the value of (S) for a binary value of 11 to determine whether the IP access list table is to be cleared in Step 16 and an output is generated to an I/O port to illuminate the connect status LED indicator (Step 17) to red, signifying that the communications path has been disabled and is disconnected. The Mode value “M” will now resolve the type of host disconnection that will be implemented. If the Mode value “M” is binary value 11 (Logical Mode) (Step 32) only DHCP (RFC 2131) type packet messages are processed and allowed by the configurable communications controller 108 between the host 102 and network 100 Ethernet ports. By allowing only DHCP type messages to be processed and forwarded within the TCP/IP stack by the configurable communications controller, the host is logically disconnected from the network and no other TCP/IP communication can be initiated by any of the connected host or hosts. However, the host or hosts will retain their IP address that has been originally assigned from the service providers DCHP server, and will be able to maintain its lease time via such DHCP messages.

If the mode value “M” is equal to binary value 01, physical mode, (Step 31) all packet transmission between the host 102 and network 100 Ethernet ports is completely ceased by the configurable communications controller 108. With no packet transmission being allowed between the two Ethernet ports, it effectively establishes a physical disconnect of the connected devices. The host computer will now relinquish the hold on its IP address after the lease time expires on the DHCP server. If the IP address was originally statically assigned it will be reassigned after a reconnection is established by manual intervention by depressing the connect button 120. Step 32 also updates transmit and receive indicator bits “I” stored in four single bit memory locations. Two single bits are used to indicate valid and discarded transmit packets originating from the host, and two bits are used to indicate valid and discarded receive packets originating from the network port. Only one of the bits will be set to a binary value of 1 in either direction at any time, and is read in from memory in Step 26 to update the intuitive LED display 126. Valid packets will be displayed by the transmit and receive link LEDs switching from green to off to green, and invalid packets will be displayed by the transmit and receive link LEDs switching from green to red to green.

In Step 14, if the interrogated value of “S” is equal to the connection state a binary value of 01, the connect button has been manually depressed. At Step 19, RTCC Timer value “T” is started and is subsequently incremented. The subsequent Step 20 instructions are executed to retrieve the host's data activity flag “A” from memory that is updated from the packet inspection process in Step 25. Next (Step 21), timer value “T” is checked to see if its value has exceeded the warning value of “W”. (Step 22) If timer value is less than this value “W”, instructions are executed to send via an I/O port a binary value to illuminate the connection status LED indicator green signifying a connection between exists between the connected host or hosts and the Internet. (Step 23) The value of the host data activity flag “A” is checked in memory to determine if it is a binary value of 1 indicating valid host packet activity from the host Ethernet port. If the data activity flag value “A” equals binary value of 0, the Timer value “T” and activity flag value “A” is not reset by Step 24 and the established TCP/IP connection between the privacy devices ports is subjected to the packet inspection rules contained in Step 25 followed by the updating of the inbound and outbound transmission link status LED's (Step 26).

The process is repetitive whereby the mode value “M” is checked again as well as the current connect state of value “S” and the timer value “T” is incremented and checked to see it has exceed the warning value of “W”. (Step 23) The data activity flag value “A” is checked again, and if the value equals a binary 1 indicating there was valid outbound TCP/IP traffic initiated from the host Ethernet port. (Step 23) With data activity flag indication “A” equaling a binary value of 1, both the Timer value “T” and data activity flag value “A” are reset in memory back to binary value of zero in Step 24. This reset event keeps the current host to network connection established though the privacy protection device as long as there is valid Internet requests originating from the host Ethernet port. (Step 20) If the data activity flag “A” remains a binary value of 0, indicating no valid transmit data activity originating from the host Ethernet port and the value timer “T” (Step 21) reaches a value greater than or equal to value “W”, instructions are executed to send via an I/O port signals to start flashing on and off (Step 27) the connection status LED green. This flashing state is a warning that the current host to network connection state will only remain active until the timer value “T” reaches a value (Step 30) equal to or greater than value “x”. Within this warning window time period equal to time value “X” minus time value “W”, either one of two processes can occur to reset timer “T” in (Step 24) to prevent the forthcoming Ethernet host port disconnection. (Step 28) The connection can be prolonged by either having the valid data activity flag “A” being reset back to a binary value of 1 by valid outgoing Internet transmission originating from the host port in module (Step 25), or by (Step 29) manual intervention whereby the connect button 120 is manually depressed again and the button value “B” (Step 5) equals a binary 01 once more. If neither of these events occur (Step 28), or (Step 29) before the timer value “T” (Step 30) is equal to or exceeds value “X”, instructions are executed by the configurable communications controller 108 (Step 17) to an I/O port to illuminate the connect status LED to red and proceed to Step 18 with either a logical or physical disconnection depending on the user selected Mode and the value “M” in Step 18.

At any time, the connection can be manually terminated by depression of just the disconnect button 122 or depression of both buttons 120 and 122 (Step 29) and subsequently processed by Step 15 to determine the disconnection selected. After proceeding with the logical, physical or manual disconnection process (Step 18), the subsequent process (Step 33) resets all the state variables back to binary value zero in active memory. The following procedure updates any port activity (Step 26) indicating any inbound or outbound data transmission.

The process continually awaits the next connection state by processing sequentially one of three continuous loops depending on the Mode selection “M”: Manual mode (Steps 4, 5, 6, 9, 10, 11, 12, 15 or 15 and 16, 17, 18, 32, 33, 26, and 34), or Logical mode (Steps 4, 5, 6, 9, 10, 11, 14, 15 or 15 and 16, 17, 18, 32, 33, 26, and 34), or Physical mode (Steps 4, 5, 6, 9, 10, 11, 14, 15 or 15 and 16, 17, 18, 31, 33, 26, and 34), until the connect button 120 is manually depressed.

The connection states will process the following three loops, depending on the Mode selection: Manual mode, (Steps 4, 5, 6, 9, 10 or 7 and 8, 11, 12, 13, 25, 26, and 34); Logical mode, (Steps 4, 5, 6, 9, 10 or 7 and 8, 11, 14, 19, 20, and (Steps 21, 22, 23 or 23 and 24, 25, 26, 34) or (21, 27, 28, 29) or (28 and 24, 25, 26, 34) or (28, 29, 24, 25, 26, 34), or (28, 29, 30, 25, 26, 34); Physical mode, (Steps 4, 5, 6, 9, 10 or 7 and 8, 11, 14, 19, 20, and (21, 22, 23 or 23 and 24, 25, 26, 34) or (21, 27, 28, 29) or (28 and 24, 25, 26, 34) or (28, 29, 24, 25, 26, 34), or (28, 29, 30, 25, 26, 34).

The manual connect and disconnect controls 120 and 122 are always enabled regardless of what user Mode is selected, and whenever a connection state exists between the host 102 and network 100 ports, the intelligent packet inspection processes of Step 25 are continuously enabled as seen from the above aforementioned connection states.

The real time packet inspection module (Step 25) consists of an intelligent packet inspection and filtration process that is continually invoked when a connection state exists on the privacy protection device between the host 102 and network port 100 as indicated on the flow chart in FIGS. 2a and 2b. The module contains a complete proprietary TCP/IP protocol stack and will process and inspect packets between the host 102 and network 100 Ethernet controllers. This module provides the necessary and vital network layer of security when the host is connected to the Internet or attached network.

The module (Step 25) provides for a multiplicity of algorithmic routines and verification procedures to ensure the highest possible security to safeguard against host detection, intrusion, and malicious attacks. The complex access routines will process and monitor all inbound and outbound packet transmissions between the connected host and LAN or Internet. The policy and rules set will perform packet authorization at the network, transport and application layers. It contains a list of filtering rules specifically tailored that allow secured connections to be established only from the host side port. As it inspects each packet of information, it will only allow verified packets back to the host that the user or users has explicitly requested. The policy and rules set does not provide for Telnet or any type of remote access, as this would be considered a serious breach of security. These associated ports are fully blocked from the network side but are only allowed to establish from the host side of the privacy device. The policy and rules set does not allow for direct peer-to-peer communication unless the host has specifically initiated the session to such a host or hosting server. This module (Step 25) is designed to provide for absolute security and eliminate malicious attacks and deny denial of service attacks, ARP spoofing, syn flood attacks, land attacks, Smurf attacks, backdoor Trojans, ping queries, trace routes, fragmented and malformed packets, port flooding, UDP scans, and the scanning of any application ports.

The real time packet inspection module (Step 25) will self generate an IP access list table that is stored in active memory 116, by keeping track of user sessions that only originate from the host Ethernet port 102. The IP access list session entries are read in from memory 116 and are utilized by a real time packet inspection policy rules set. The policy rules set is a suite of pre-defined security checks including filtering routines that are stored and retained in non-volatile memory 114 and is part of the purpose built operating system. The rules set is structured to apply stateful authentication of both TCP (RFC 793) and UDP (RFC 768) transport layer protocols of the TCP/IP Internet reference model and will deal with the IP access list of session entries created by host requests in order to determine whether messages are expected responses to be forwarded to the host or immediately discarded. The real time packet inspection module does not provide or determine routing like a conventional router that requires pre-programmed information on what IP addresses are to be forwarded to what specific interfaces. Instead the real time packet inspection rules defaults all verified information back to the single host Ethernet interface 102 by default.

The module (Step 25) uses an active connection approach that allows TCP/IP sessions from the host computer to establish connections through the privacy device only when the host issues a request based on an instruction from its own upper layer protocol that provides the source and destination IP address, the source and destination socket number and other parameters within the TCP/IP header to the privacy devices host port 102. This method only allows host originated connections to be established as the host opens up different ports dynamically based on the various applications the user initiates. Ports that are opened on the host computer do not have to be uniquely preset or preprogrammed into the privacy device as in the case of most conventional firewall appliances. Instead, requests applied into the host port of the privacy protection device are mapped along with IP source address, destination address, source port, destination port, protocol type, packet sequence number and selected other parameters within the TCP/IP header. Any passive ports whether open or closed on the host computer, awaiting a connection from an active request from the network are forced blocked by the privacy protection device as it only allows connections that are currently active in the IP access list table. Any type of TCP or UDP port scanning from the network side of the privacy device will exhibit that all application ports are fully blocked.

The host IP access list table is dynamically created and updated as user sessions are initiated and established from the host port to the connected network. The IP access list table restricts all unsolicited TCP and UDP network side traffic attempts from gaining access to the host after being rigorously inspected and filtered for source address, destination address, port number, protocol type, packet sequence number and other parameters contained within the IP packet header including the employed protocol. Returned information from the network port 100 is checked and verified for an exact match on all parameters contained within the IP access list table by the rules set, and will only allow those session matches to return information that the host has specifically requested. The IP access list table can support from one to a multiplicity of host addresses equal to the number of global IP addresses being made available on the network side of the privacy device. The module (Step 25) does not provide DHCP services or any type of Network Address Translation. If only one global IP address is available on the network side, a proxy server could be connected to the host port to support multiple private IP addresses for a LAN through the device. The host generated session entries stored in the IP access list table, are timed out dynamically after a fixed timer period of value “D” upon subsequently determining that the session entry has not been referenced and has remained inactive in the IP access table list. All host generated access entries contained in the IP access list table are time tagged and are continuously monitored for exceeding this idle inactive timeout value of “D” and are subsequently removed from the IP access list table within the module (Step 25).

The value of timer “D” is sufficiently smaller than the TCP keep-alive timer value that is active within the host's TCP/IP stack that sends an empty packet at regular intervals to ensure the connection to the other machine is still active. This ensures that an inactive connection session residing within the IP access list will be removed from the IP access list table before a keep-alive packet resets timer “D” for that specific connection session. The saved session will reach timer value “ID” and be deleted prior to receiving a TCP keep-alive packet if no user host Internet activity takes place by the host.

This continual monitoring of the access list entries establishes a maximum timeframe in which an active connection or URL can respond back through the privacy protection device but only after the host has initiated the communication session with such associated URLs. The absolute time value of the access list timer “D” is less than the connection expiry timer value “X”, which controls the connection between the host and network ports on the privacy protection device. The combination of the two coexisting timer periods “X” and “D” in Step 30 and Step 25 creates an extremely secure and optimal window of transmission time for all host initiated sessions by limiting both the exposure time of the host connection to the connected network, and the maximum permissible time for an authorized session request to respond back or initiate to the host through the privacy protection device. Once the timer value “T” exceeds value “X” in Step 30 or by manual depression of the disconnect button 122 whereby a logical or physical disconnect is established between the host and network ports, no host initiated session entries can be reentered into the IP access list table until manual intervention is firstly present by depressing the connect button 120. In addition, valid network sessions that are still current within the access table after a manual disconnect and prior to timer “T” reaching value “X” and fully expiring are not processed or acted upon and therefore are inactive. Host originated sessions cannot be established or network responses accepted during any of the disconnection states determined in Step 18.

The information arriving into the host port 102 is filtered and monitored for valid network layer type requests in Step 25. Host requests are continually inspected for valid network layer URL traffic requests whereby the data activity flag “A” is updated and set to a binary value 1 in Step 20 and is furthermore interrogated in Steps 23 and 28. The host arriving data is intelligently filtered and checked to eliminate any unwanted packets such as ARPS and other chatty LAN traffic from falsely triggering and setting the data activity flag “A” to a binary 1 value in Step 20. This data activity flag “A” value is used as a traffic indicator to detect whether valid host activity and user presence exists. If the flag is equal to a binary value of 1 it will reset the inactivity timer value “T” in Step 24. This data activity flag “A” keeps the host and network ports enabled and connected as long as there is valid traffic being received at the host port 102. Once the value of timer “T” reaches value “X” without being reset by activity flag “A”, i.e. the user is no longer on the host system, the host and network ports 102 and 100 will be disconnected on the privacy protection device accordingly as detected by the mode value “M” in Step 18.

The real time packet inspection rules set is designed not to respond to any type of inbound Internet layer ICMP queries such as ping requests (RFC 792) that determine whether a host is capable of communication, and fully suppresses such requests by discarding them. Therefore ICMP commands such as traceroute used to trace a route will not return a valid path, and ping commands will receive a destination unreachable response towards the sender from the connected network. This default feature makes port scans and probes ineffective in finding any addresses of the devices located behind the privacy protection device. The ICMP messages never reach the destined host computer and thus cannot respond to these ICMP requests. Additionally incorporated into the real time packet inspection rules set are particular timers and algorithms that detect repetitive and continuous messages like ICMP ping requests whereby rate control is enabled to mitigate any flooding or denial of service attempts. The feature will immediately drop all packets coming from the hostile source by monitoring rate interval and recognizing that the packets are from the same source but at a deviant rate.

Additional algorithms are utilized to detect anomalies in which other information in the packets, such as packet types, TCP flags, and port numbers, where flooding can be detected from reflector and indirect attacks. Attacks such as SYN flooding where a large quantity of TCP SYN packets are sent to a host's application port are completely blocked and do not reach the TCP/IP stack within the host computer, thus eliminating any half-open connections.

The module in Step 25 does not offer network address translation (NAT) in order to allow virtual private network (VPN) connections to be established through the privacy protection device. NAT is based on RFC 1631 and is typically used to connect a private network to a public network, such as connecting a company's network to the Internet. Step 25 will allow multiple IP address assignments from the host port 102 to be mapped into the access table to as many unique registered global IP addresses that are made available from the Internet service provider or connected network. This methodology eliminates many problems associated and encountered in VPN connections that cannot be established because NAT does not only swap IP source and destination addresses, but it may also swap TCP source and destination ports, change IP and TCP header checksums, change the TCP sequence and acknowledgement numbers, and change IP addresses contained in the data payload. Many security devices will disallow a VPN client from a workstation with a non-routable (private) IP address only to find out that the network address translation (NAT) on the router or gateway keeps the VPN client from making the connection. In Step 25 the VPN is totally transparent to whatever application is being provided by the host as the module does not change or modify the IP addresses and preserves both TCP and UDP information contained within the header. The module also accommodates IPSec or L2PT whereby a VPN gateway encapsulates/encrypts the layer three address of a packet with another layer three address, and stripping it off on the other side of the network. The module does not provide any type of DHCP services but does allow DHCP UDP messages to pass between the network and host Ethernet interfaces 100 and 102 enabling the connected host or hosts to communicate to a service provider's DHCP server permitting the use dynamic IP address assignment.

The algorithm that is invoked when writing host initiated sessions into the IP access list in Step 25, resourcefully uses the limited RAM space contained within the configurable communications controller 108. The algorithm uses two timing techniques whereby the stored access list sessions in memory are selectively purged and thus memory over-write is dynamically controlled and security is increased. First, the host generated session entries that are stored in the IP access list table, are timed out systematically after reaching a fixed timer period of value “D” upon subsequently determining that the stored session entry has not been referenced and has remained inactive within the IP access table list. All host generated access entries contained in the IP access list table are time tagged and are continuously monitored for exceeding this idle inactivity timeout value of “D” and are subsequently removed from the IP access list table within Step 25.

The second technique allows the IP access list to write over itself if the access list reaches capacity, overwriting these held sessions currently in memory starting with the oldest time tagged session entries even though they have not reached the expiry time value of “D”. When the IP access list reaches capacity, a second purge timer is enabled to expedite the purging process of sessions within memory. In order to not write over a session that might be currently in progress, a session entry can only be overwritten upon determining that the IP access list is full and the saved session has remained inactive in memory for a minimum and fixed time period of “F”. If all sessions within the full access list are determined to be inactive for a period less than time “F”, existing mapped sessions cannot be overwritten and any newly unmapped sessions will be discarded and cause the web browser request to be delayed within the TCP/IP stack on the host computer. The host URL request will remain active or require a retry until an existing IP access memory space becomes available by either a current session entry reaching timer value “D” or an entry becoming eligible to be overwritten because it has exceeded timer value “F” when the access list map was determined to be full. The adaptive purge timer function results in the maximum amount of persistent IP access memory space being made accessible for any newly host requested sessions.

A further consequence of this purging process results in greatly increasing the level of security by timing out stale sessions from previous host session requests. Previous timed out sessions cannot re-establish communications back to the host again unless the host re-initiates a new session to those URLs. The IP access list can be manually purged at any time if the user wants an immediate disconnection from a previously trusted connection session by depressing both connect and disconnect buttons 120 and 122 simultaneously and setting “S” to binary value 11 and clearing the IP access table in Step 16. A connection is necessary again by the manual depression of the connect button 120 whereby new sessions can be subsequently established again.

In addition, Step 25 also updates transmit and receive indicator bits “I” stored in four single bit memory locations. Two single bits are used to indicate valid and discarded transmit packets originating from the host, and two bits are used to indicate valid and discarded receive packets originating from the network port. Only one of the bits will be set to a binary value of 1 in either direction at any time, and is read in from active memory in Step 26 to update the devices intuitive LED display 126. Valid packet transmission will be displayed by the transmit or receive link LEDs switching from green to off to green, and invalid discarded packets will be displayed by the transmit or receive link LEDs switching from green to red to green. Invalid packets in Step 25 are packets that have been discarded and disallowed by the rigorous packet inspection processes in Step 25 including all ICMP type packets. Valid packets in Step 25 are packets that have been fully verified by the inspection processes in Step 25 and consist solely of information the host has specifically requested.

Steps 25, 31 and 32 are responsible for updating the indicator “I” bit values in inactive memory whereby Step 26 will continuously read and output the information to provide the visual intrusion indications on the privacy protection device. The “I” bits are only updated by any one of the three steps depending what connection state and mode the privacy device is currently in. Steps 25, 31 and 32 will update four single bit memory locations that will be subsequently read in and outputted by Step 26 to provide visual indications of the validity of data transmission through the privacy protection device. Instructions are executed to fetch and read the four bits from memory. These four bits are outputted via an I/O port to turn off or on the link status LEDS accordingly. The four memory locations are divided into two transmit and two receive indications. The two states that can be indicted are valid packet transmission, indicated by the link status LED going from green to off to green, and invalid packets being discarded, whereby the link status LED goes from green to red to green. Step 26 reads all memory locations representing both directions looking for a binary value of 1 in either of the two memory positions and updates accordingly via instructions to output via I/O ports an update of the inbound and outbound link status LEDs. Any packet transmission originating from the host or network ports will either flash red or off from solid green for a minimum visual period of “Y” for all packet transmission.

After completion of reading and outputting the stored memory values of indicator information via an I/O port to update the visual LEDs, Step 34 subsequently resets all four “I” bits in memory back to a binary value of zero. The “I” bits will then be dynamically updated again in memory by one of the Steps 25, 31 or 32 depending on the mode and connection state of the privacy protection device.

Accordingly, while this invention has been described with reference to illustrative embodiments, this description is not intended to be construed in a limiting sense. Various modifications of the illustrative embodiments, as well as other embodiments of the invention, will be apparent to persons skilled in the art upon reference to this description. It is therefore contemplated that the appended claims will cover any such modifications or embodiments as fall within the scope of the invention.

What is claimed is:

1. A privacy protection device to provide secure access to a computer network, comprising:
a) a host port connected to one of: a computer, and a network of computers;
b) a network port connected to said computer network;
c) a communications controller connecting said host port to said network port, said communications controller generating a single IP access list for monitoring and controlling communication between said host port and said network port;
d) active memory coupled to said communications controller, said active memory storing said IP access list; and
e) program memory coupled to said communications controller, said program memory storing an operating system (OS) and a TCP/IP stack with a rules set for said communications controller to monitor and control communications,
wherein said privacy protection device has a logical disconnection mode which allows said computer to maintain its IP address while being otherwise disconnected from said computer network.

2. The privacy protection device according to claim 1, wherein said computer network is the Internet.

3. The privacy protection device according to claim 1, wherein said privacy protection device also has a physical disconnection mode which provides for a complete disconnection from said computer network which does not preserve said IP address of said computer and prohibits all communication between said host port and said network port.

4. The privacy protection device according to claim 3, wherein said physical disconnection mode is selected by a user-controlled switch on said privacy protection device.

5. The privacy protection device according to claim 3, wherein said privacy protection device can be switched between said logical disconnection mode and said physical disconnection mode by a user-controlled mode switch on said privacy protection device.

6. The privacy protection device according to claim 5, wherein said privacy protection device can be switched to a non-disconnection mode via said user-controlled mode switch.

7. The privacy protection device according to claim 1, further comprising an auxiliary port coupled to said network port, said auxiliary port providing for unmonitored communication between a device coupled to said auxiliary port and said computer network.

8. The privacy protection device according to claim 1, wherein said privacy protection device automatically enters said logical disconnection mode if there is no communication received from said host port after a preset time period.

9. The privacy protection device according to claim 8, wherein said logical disconnection mode only allows TCP UDP ports 67 and 68 to be active on said TCP/IP stack to pass DHCP communication messages between said host port and said network port.

10. The privacy protection device according to claim 1, further including a status display that displays link status, connection/disconnection status and intrusion status.

11. The privacy protection device according to claim 3, wherein said privacy protection device automatically enters one of said logical disconnection mode and said physical disconnection mode if there is no communication received from said host port after a preset time period.

12. The privacy protection device according to claim 11, wherein said device provides a warning indication on said device when said preset time period is about to expire.

13. The privacy protection device according to claim 12, wherein said preset time period can be reset and restarted by a user-controlled button on said device.

14. The privacy protection device according to claim 1, wherein said logical disconnection mode can be activated immediately by a user-controlled button.

15. The privacy protection device according to claim 3, wherein one of said logical disconnection mode and said physical disconnection mode can be activated immediately by a user-controlled button.

16. The privacy protection device according to claim 11, wherein said preset time period can be reset and restarted by the extraction, filtration and detection of communication intended for said computer network entering said host port.

17. The privacy protection device according to claim 1, wherein said logical disconnection is seamless, such that no Physical Layer 1 media alarms indications are triggered on said computer and on said computer network.

18. The privacy protection device according to claim 1, wherein said privacy protection device includes one or more of the following security features:
(a) no local console interface port;
(b) no web browser access for configuration, administration and maintenance;
(c) no Telnet access to said host port;
(d) no Telnet access to said network port;
(e) no logical IP address associated with said host port;
(f) no logical IP address associated with said network port;
(g) no physical MAC address associated with said host port;
(h) no physical MAC address associated with said network port; and
(i) said privacy protection device is a plug-and-play device requiring no configuration, programming, and administration.

19. The privacy protection device according to claim 3, wherein said physical disconnection is seamless, such that no Physical Layer 1 media alarms indications are triggered on said computer and on said computer network.

20. The privacy protection device according to claim 3, further including a user-controlled connection button that must be activated to re-establish communication between said host port and said network port after one of said logical disconnection mode and said physical disconnection mode is activated.

21. The privacy protection device according to claim 20, wherein said user-controlled connection button is the sole means of re-establishing communication between said host port and said network port.

22. The privacy protection device according to claim 1, wherein said TCP/IP stack is prohibited from acknowledging and responding to any ICMP requests from said computer network.

23. The privacy protection device according to claim 1, wherein said privacy protection device detects continuous and repetitive messages and automatically applies rate control in order to mitigate port flooding and denial of service attacks.

24. The privacy protection device according to claim 1, wherein said communications controller extracts header information from an IP session to generate said IP access list, said header information including one or more of the following:
(a) layer 3 header information, 16-bit source and 16-bit destination IP addresses;
(b) layer 2 header information, 16-bit source and 16-bit destination port addresses;
(c) a 32-bit layer 2 sequence number;
(d) protocol type; and
(e) other protocol-dependent fields found within said header information.

25. The privacy protection device according to claim 24, wherein said IP access list can support a plurality of public IP addresses from a plurality of computers without using Network Address Translation.

26. The privacy protection device according to claim 24, wherein said IP session is encrypted using IPsec.

27. The privacy protection device according to claim 3, wherein said IP access list no longer receives new entries during a logical disconnection and during a physical disconnection.

28. The privacy protection device according to claim 10, wherein said status display uses dual color indicators to show current connection status between said host port and said network port.

29. The privacy protection device according to claim 28, wherein said status display further includes a warning indicator to show an ongoing intrusion attempt.

30. The privacy protection device according to claim 1, further including an access timer to monitor individual entries on said IP access list.

31. The privacy protection device according to claim 30, wherein the value of said access timer is dynamically controlled according to the number of entries on said IP access list.

32. The privacy protection device according to claim 30, wherein one of said individual entries on said IP access list is deleted when said access timer reaches a pre-determined value with respect to said one individual entry and a response corresponding to said one individual entry has not been received.

33. The privacy protection device according to claim 31, wherein said access timer can be reset by a request from said computer associated with an IP session on said IP access list.

34. The privacy protection device according to claim 1, wherein one or both of said host port and said network port are coupled to an internetworking device, said internetworking device operating at layer 1, layer 2, layer 3 and a combination thereof.

35. The privacy protection device according to claim 1, wherein said device is located in the digital baseband path between said computer and said computer network.

36. The privacy protection device according to claim 1, wherein said device is independent of an operating system running on said computer and said network of computers.

37. The privacy protection device according to claim 1 or 3, wherein said device distinguishes and allows static and dynamic IP address assignment.

38. The privacy protection device according to claim 1, wherein said device only permits communications from said computer network which have been initiated by said computer connected to said host port.

39. The privacy protection device according to claim 1, wherein said program memory resides as non-volatile firmware within said communications controller.

40. The privacy protection device according to claim 1, wherein said rules set prohibits certain protocols deemed untrustworthy from passing between said host port and said network port.

41. The privacy protection device according to claim 1, wherein said device reports all ports on said TCP/IP stack as blocked regardless on any port permission settings on any computer connected to said host port.

42. The privacy protection device according to claim 25, wherein said device permits virtual private network (VPN) connections.

43. The privacy protection device according to claim 1, wherein said IP access list can be manually purged at any time by a user-controlled button.

44. The privacy protection device according to claim 1, wherein said communications controller and said IP access table use only said host port, such that routing algorithms and switching algorithms are not used.

45. A method of controlling communications between a computer and a computer network via a privacy protection device, comprising the steps of:
a) passing a URL request datagram from said computer to a destination on said computer network through a communications controller within said privacy protection device;
b) extracting IP header information from said URL request datagram, said IP header information including said computer's IP address, said destination's IP address, associated port addresses, sequence number and protocol type;
c) storing said IP header information on an IP access list;
d) forwarding said URL request datagram to said destination to receive a response;
e) passing said response from said destination through said communications controller;
f) extracting IP header information from said response;
g) comparing said IP header information from said response with said IP header information stored on said IP access list;
h) forwarding said response to said computer if said IP header information from said response matches said IP header information stored on said IP access list; and
i) rejecting said response if said IP header information from said response does not match said IP header information stored on said IP access list.

46. The method according to claim 45, wherein said comparing step incorporates a packet inspection algorithm that allows for detection and rejection of spoofed and redirected responses.

47. The method according to claim 45, wherein said method allows said computer to maintain its IP address while rejecting all communications between said computer and said computer network.

48. The method according to claim 47, wherein said communications controller allows TCP UDP ports 67 and 68 to be active and pass DCHP communication messages between said computer and said computer network while rejecting all other communications between said computer and said computer network.

49. The method according to claim 45, wherein rules for extracting and comparing said IP header information are stored in program memory coupled to said communications controller.

50. The method according to claim 45, wherein said IP header information includes one or more of:
(a) layer 3 header information, 16-bit source and 16-bit destination IP addresses;
(b) layer 2 header information, 16-bit source and 16-bit destination port addresses;
(c) a 32-bit layer 2 sequence number;
(d) protocol type; and
(e) other protocol-dependent fields found within said header information.

51. The method according to claim 45, wherein said communications controller rejects all ICMP requests without subjecting said ICMP request to said comparing step.

52. The method according to claim 45, wherein said communications controller detects continuous and repetitive messages and automatically applies rate control to mitigate port flooding and denial of service attacks.

53. The method according to claim 45, wherein said IP access list is monitored by a timer and said IP header information is removed from said IP access list when said timer reaches a pre-determined value with respect to said IP header information and a response corresponding to said IP header information has not been received.

54. The method according to claim 53, wherein said timer can be reset and restarted with respect to any IP header information stored on said IP access list for a particular IP session by a fresh request from said computer using said IP header information.
